(19) United States
(12) Patent Application Publication
(10) Pub. No.: US 2010/0281934 A1
(43) Pub. Date: Nov. 11, 2010

(54) Electronic-controlled magnetic lock anti-theft unit for coffer

(76) Inventor: Ming-Jhou Su, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,251

(22) Filed: May 5, 2009

(51) Int. Cl. E05B 47/02; E05B 49/00

(52) U.S. Cl. 70/278.1

(57) ABSTRACT

This invention relates to an electronic-controlled magnetic lock anti-theft unit for coffer in which a magnetic lock and a latch unit are assembled on the door panel of a coffer, a pivoting plate being provided between the magnetic lock and the latch unit, and an anti-theft unit at the lateral side of the latch unit. When a thief begins to turn the coffer upside down to steal, a stop post of the anti-theft unit falls down to engage in the latch unit by gravitational effect. In this manner, even if the engaging plate is disengaged from the magnetic lock, the latch unit is unable to be wrenched for unlocking. Therefore, the purpose of anti-theft can be achieved.

### BACKGROUND OF THE INVENTION

1. Field of the Invention

The present invention relates to an electronic-controlled magnetic lock anti-theft unit for coffer, particularly to an anti-theft unit assembled on the door of a coffer in which a stop post of the anti-theft unit falls down to engage in the latch unit by gravitational effect when a thief begins to turn the coffer upside down to steal. In this manner, even if the pivoting plate is disengaged from the magnetic lock, the latch unit is still unable to be wrenched for unlocking so that the purpose of anti-theft can be achieved.

2. Brief Description of the Prior Art

Social problems have been uninterruptedly triggered by the growing disparity between rich and poor. Thus, thieves become ever more common. A variety of lock and coffer have been proposed to protect private property, in which conventional coffer lock is mainly formed by a disk type lock in cooperation with a latch unit. When the notches provided on a plurality of rotary plates stacked together are rotated to a predetermined direction, the latch unit is activated with respect to the notches so as to open the coffer. However, the disk type lock formed by a plurality of rotary plates has very complicated structure and is very difficult in assembling and manufacturing. In practical application, the knob should be rotated in clockwise and counterclockwise direction repeatedly and accurate figures should be aligned. Therefore, the operation takes a lot of time and is very inconvenient.

In view of the above defect, a magnetic lock (6) is proposed as shown in FIG. 5 in which a secret code is input by pushing the keyboard to turn on the power so that the magnetic controlled member (61) initially engaging the pivoting plate (7) is detached from the engagement with pivoting plate (7). Thus, the latch unit (8) can be displaced to retreat from the locking position so as to release locking state of the lock. When demagnetized, the magnetic controlled member (61) is returned to its original position by gravitational force occurred due to its own weight and by the pushing action of elastic force provided from an elastic member (62) so that the lock is locked.

Inasmuch as the working principle of the magnetic lock (6) is to release the locking action of the latch unit (8) by electromagnetically sucking the magnetic controlled member (61), originally engaged with the pivoting plate (7), and to detach from the engagement therewith and to return the magnetic controlled member (61) to its original position both by gravitational force occurred due to its own weight and by the pushing action of elastic force provided from an elastic member (62) in normal state so as to trigger the locking action by the engagement with the pivoting plate (7), thieves often turn the coffer upside down, as shown in FIG. 6, so that the weight of the magnetic controlled member (61) is acted upon the elastic member (62) to offset the elastic force acted on the magnetic controlled member (61). Then, through drastic shaking, the constant pushing action from the elastic member (62) to the magnetic controlled member (61) is changed so that the magnetic controlled member (61) might detach from the engagement with the pivoting plate (7). If so, thieves can wrench the latch unit (8) to retreat from its locking position and release the lock state for stealing.

In view of the above defects that the magnetic controlled member might detach from the engagement with the pivoting plate due to the turning upside down and drastic shaking conducted on the magnetic lock of the coffer by thieves, inventor of the present invention conducts improvements on the defects of the existing magnetic lock of coffer based on his abundant experience of R&D and manufacturing in relevant field so as to attain better performance in practical application.

### SUMMARY OF THE INVENTION

The present invention relates to an electronic-controlled magnetic lock anti-theft unit for coffer, the purpose of which is to provide an easy-to-design anti-theft unit that can effectively prevent the magnetic lock of coffer from cracking down and the properties from being stolen.

In order to achieve the above object, the electronic-controlled magnetic lock anti-theft unit for coffer according to the present invention has a magnetic lock and a latch unit assembled on the door panel of a coffer, an pivoting plate being provided between the magnetic lock and the latch unit, and an anti-theft unit being provided at the lateral side of the latch unit, wherein:

said magnetic lock further comprises: a keyboard provided at the outside of the door panel; a power source unit provided at the inside of the door panel and connected with said keyboard; a solenoid unit connected with said power source unit; a magnetic controlled member, the rod of which is in magnetic actuation relationship with the solenoid unit, an elastic member being inserted onto the rod of the magnetic controlled member, a stop block being attached to the upper end of the rod of the magnetic controlled member so as to block the pivoting plate;

the latch unit comprises: a plurality of latch blocks, a connecting plate connected with the latch blocks, and a guide plate in connection with the connecting plate, the guide plate being formed with a guide slot in which a guide block connected with the door panel is guided therein, a stop edge for engaging with the stop post of the anti-theft unit being formed on the guide plate at the other end opposite to the end connected with the connecting plate, a limit notch for abutting against the pivoting plate being formed on the bottom side of the guide plate, an engaging block assembled on the connecting plate for assembling with the handle provided at the outside of the door panel;

the anti-theft unit has an assembling seat the upper and lower edges of which have through bores opposite to each other, a stop post being inserted through the through bores, a limit member being combined with the stop post for abutting against the inner faces of the upper and lower edges of the assembling seat.

In this manner, when a thieve begins to turn the coffer upside down to steal, the stop post of the anti-theft unit falls down to engage in the latch unit by gravitational effect. In this manner, even if the pivoting plate is detached from the engagement with the magnetic lock, the latch unit is still unable to be wrenched for unlocking. Therefore, the purpose of anti-theft can be achieved.

### BRIEF DESCRIPTION OF THE DRAWINGS

FIG. 1 is an entire schematic view of the coffer of the present invention.

FIG. 2 is a first perspective view of the anti-theft unit of the present invention.

FIG. 3 is a second perspective view of the anti-theft unit of the present invention.

FIG. 4 is a view showing the state of anti-theft implementation of the present invention.

FIG. 5 is an entire schematic view showing a conventional coffer.

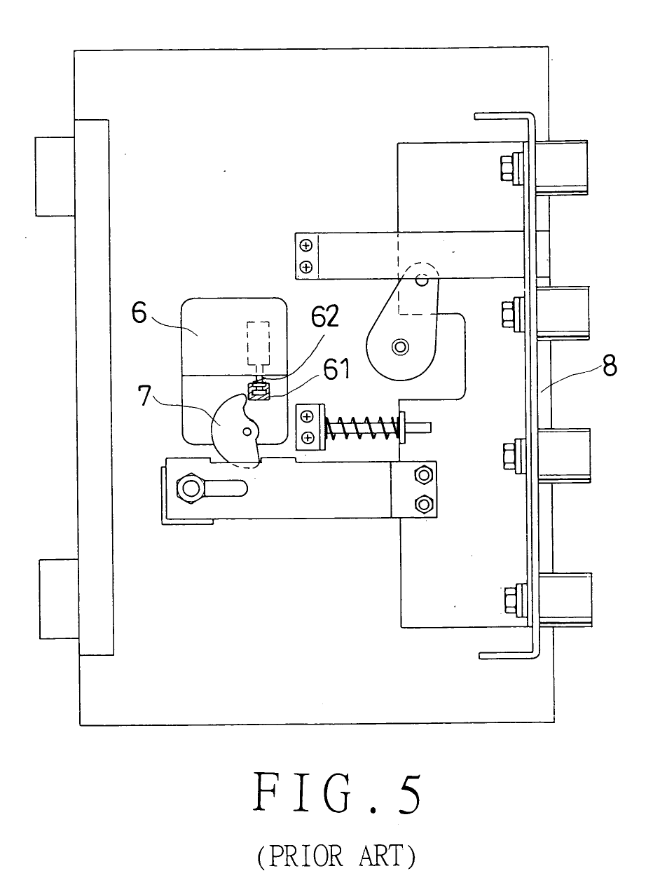

FIG. 6 is a view showing the state of being stolen of the conventional coffer.

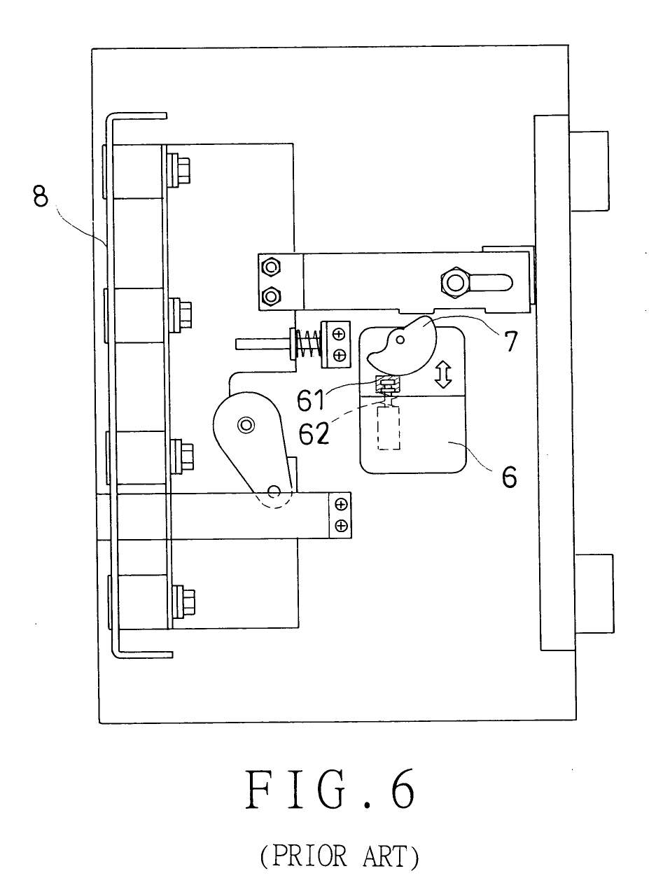

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

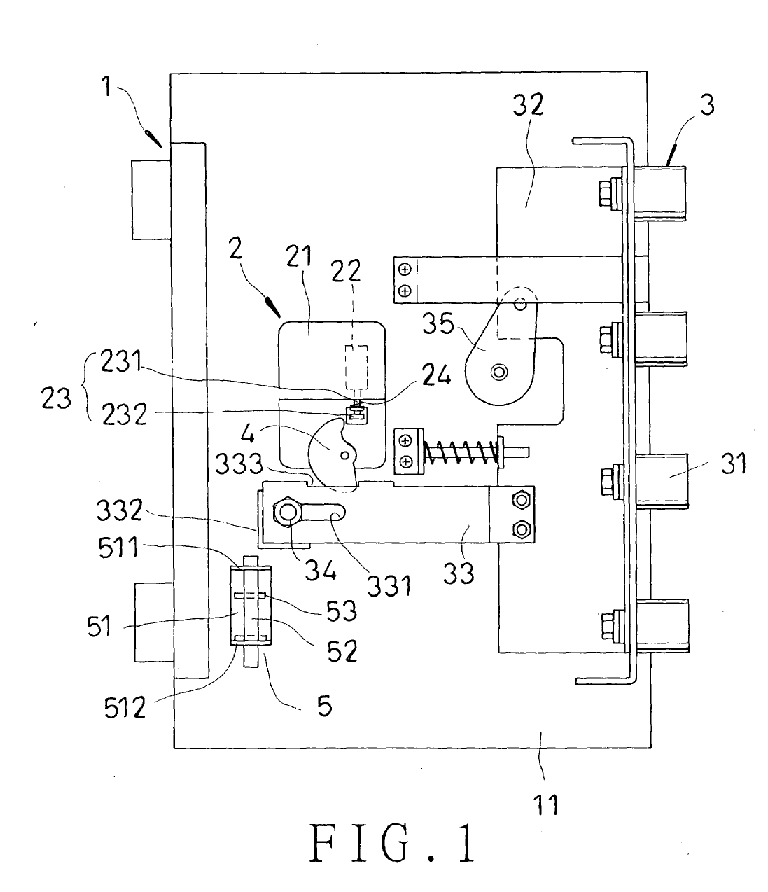

Firstly referring to FIG. 1, the electronic-controlled magnetic lock anti-theft unit for coffer according to the present invention has a magnetic lock (2), a latch unit (3), a pivot plate (4) and an anti-theft unit (5) assembled on the door panel (11) of the coffer (1), wherein:

the magnetic lock (2) comprises: a keyboard provided at the outside of the door panel (11); a power source unit (21) provided at the inside of the door panel (11) and connected with said keyboard: a solenoid unit (22) connected with said power source unit (21); a rod (231) of a magnetic controlled member (23) being in magnetic actuation relationship with the solenoid unit (22), an elastic member (24) being inserted onto the rod (231) of the magnetic controlled member (23), a stop block (232) being attached to the upper end of the rod (231) of the magnetic controlled member (23) for blocking the pivoting plate;

the latch unit (3) comprises a plurality of latch blocks (31), a connecting plate (32) connected with the latch blocks, and a guide plate (33) in connection with the connecting plate (32), the guide plate (33) being formed with a guide slot (331) in which a guide block (34) connected with the door panel (11) is guided therein, a stop edge (332) being formed on the guide plate (33) at the other end opposite to the end connected with the connecting plate (32), a limit notch (333) formed on the bottom side of the guide plate (33), an engaging block (35) assembled on the connecting plate (32) for assembling with the handle provided at the outside of the door panel (11);

the pivot plate (4) is pivotally installed at the inside of the door panel (11) and is located between the latch unit (3) and the magnetic lock (2), the upper end of the pivot plate (4) being abutted against the limit notch (333) formed on the bottom side of the guide plate (33) and the lower end of the pivot plate (4) being engaged with the stop block (232) of the magnetic controlled member (23) of the magnetic lock (2);

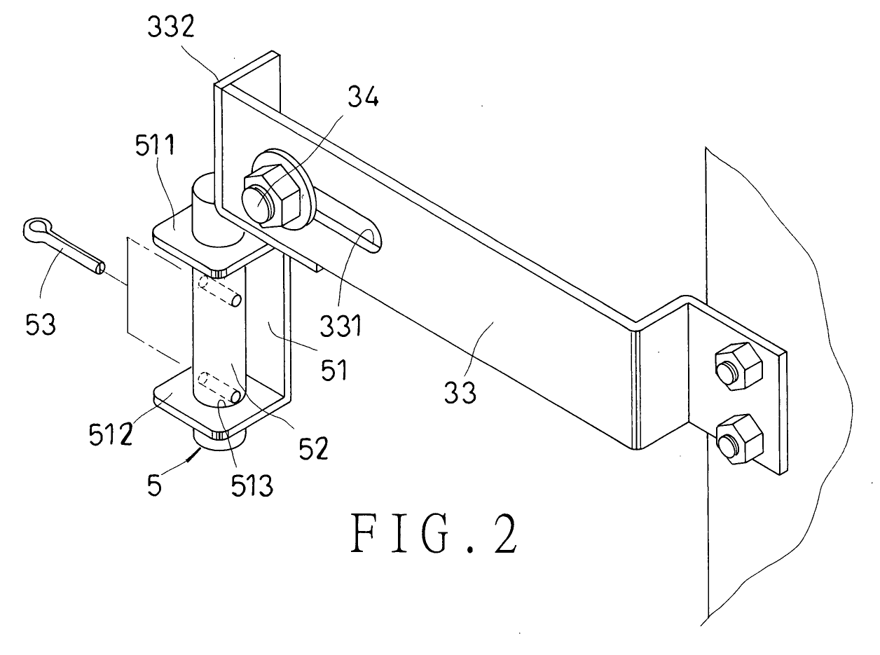

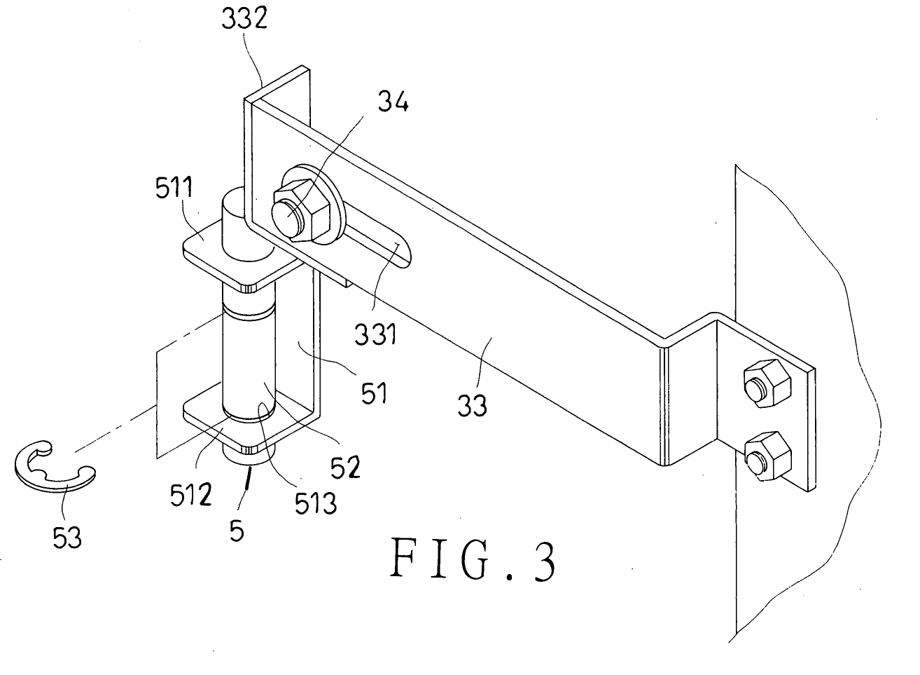

the anti-theft unit (5) as shown in FIG. 2 is assembled on the door panel (11) and is located at the lateral side of the stop edge (332) of the guide plate (33), the anti-theft unit (5) having an assembling seat (51) the upper and lower edges (511), (512) of which have through bores (513) opposite to each other, a stop post (52) being inserted through the through bores (513), a limit member (53) [the limit member (53) is a pin as shown in FIG. 2 or a C-retainer as shown in FIG. 3] being combined with the stop post (52) for abutting against the inner faces of the upper and lower edges (511), (512) of the assembling seat (51).

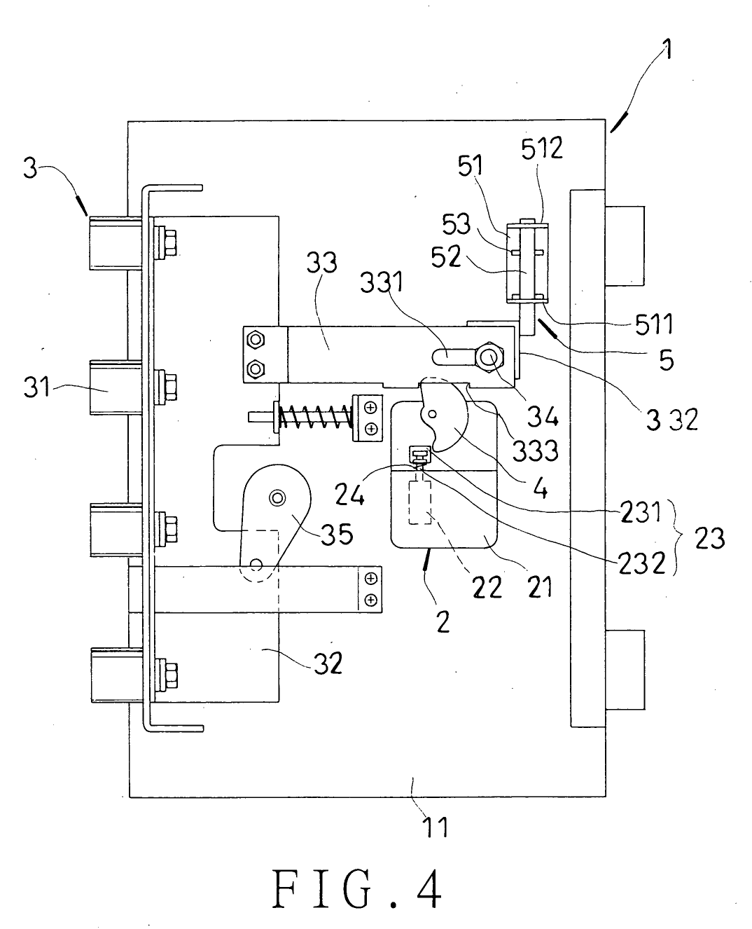

Referring to FIG. 4, when a thief begins to turn the coffer upside down to steal, the stop post (52) of the anti-theft unit (5) falls down by gravitational effect and is just blocked at the stop edge (332) of the guide plate (33) under the limit action provided by the limit member (53).

In this manner, even if the thief shakes the coffer drastically with a purpose to let the stop block (232) of the magnetic controlled member (23) disengaging from the pivot plate (4) so that the thief can enforce to wrench the latch unit (3) to detach from the locking state.

However, the stop edge (332) of the guide plate (33) of the latch unit (3) blocks against the stop post (52) such that the latch unit (3) is unable to be moved. Therefore, the purpose of anti-theft can be achieved.

Based on the foregoing, the electronic-controlled magnetic lock anti-theft unit for coffer has the advantages set forth below. 1. This invention has an anti-theft unit provided at a place corresponding to the guide plate of the latch unit and located at the inside of the door panel of the coffer. When a thief begins to turn the coffer upside down to steal, the stop post of the anti-theft unit falls down to engage in the latch unit by gravitational effect. In this manner, even if the pivoting plate is disengaged from the magnetic lock, the latch unit is still unable to be released from locking state. Therefore, the purpose of anti-theft can be achieved. 2. This invention can achieve the purpose of anti-theft by merely using a simple anti-theft unit which contains an assembling seat, a stop post penetrating the through bores provided on the assembling seat, and a limit member combining with the stop post.

Summing up above, the electronic-controlled magnetic lock anti-theft unit for coffer according to this invention can reach expected effectiveness, and the specific configurations disclosed herein have yet not seen in the prior art of the same category of product, even has not been opened to the public before application.

What is claimed is:

1. An electronic-controlled magnetic lock anti-theft unit for coffer, having a magnetic lock and a latch unit assembled on said door panel of the coffer, a pivoting plate provided between a magnetic lock and a latch unit, and an anti-theft unit installed at the lateral side of the latch unit, wherein:
said anti-theft unit has an assembling seat the upper and lower edges of which have through bores opposite to each other, a stop post being inserted through the through bores, a limit member being combined with said stop post for abutting against the inner faces of the upper and lower edges of said assembling seat.

2. An electronic-controlled magnetic lock anti-theft unit for coffer as claimed in claim 1, wherein said magnetic lock comprises: a keyboard provided at the outside of the door panel, a power source unit which is provided at the inside of the door panel and is connected with said keyboard: a solenoid unit connected with said power source unit; a magnetic controlled member, a rod of which being in magnetic actuation relationship with said solenoid unit, an elastic member being inserted onto the rod of said magnetic controlled member, and a stop block being attached to the upper end of the rod of said magnetic controlled member for blocking the pivoting plate.

3. An electronic-controlled magnetic lock anti-theft unit for coffer as claimed in claim 1, wherein said latch unit comprises a plurality of latch blocks, a connecting plate connected with the latch blocks, a guide plate being in connection with the connecting plate, the guide plate being formed with a guide slot in which a guide block connected with the door panel is guided therein, a stop edge being formed on the guide plate at the other end opposite to the end connected with the connecting plate, a limit notch being formed on the bottom side of the guide plate, an engaging block being assembled on the connecting plate for assembling with the handle provided at the outside of the door panel.

4. An electronic-controlled magnetic lock anti-theft unit for coffer as claimed in claim 1, wherein said limit member is a C retainer.

5. An electronic-controlled magnetic lock anti-theft unit for coffer as claimed in claim 1, wherein said limit member is a pin.
